(19) United States
(12) Patent Application Publication
(10) Pub. No.: US 2008/0144897 A1
(43) Pub. Date: Jun. 19, 2008

(54) Method for performing distributed analysis and interactive review of medical image data

(75) Inventors: Rakesh Mohan Lal, Waukesha, WI (US); Saad Ahmed Sirohey, Pewaukee, WI (US); Tabb Alan Patz, New Berlin, WI (US)

Correspondence Address: Patrick S. Yoder;FLETCHER YODER, P.O. Box 692289, Houston, TX, 77269-2289, US

(73) Assignee: General Electric Company

(21) Appl. No.: 11/584,189

(22) Filed: Oct. 20, 2006

(51) Int. Cl. G06K 9/00

(52) U.S. Cl. 382/128

(57) ABSTRACT

A technique is provided for improving workflow in processing and exchange of image data in a medical context. Image data may be accessed for processing, and save-state information may be generated following such processing that captures a state of an application used to process the image data files. A link to the save-state information may be stored on a common memory device and selected or executed by a radiologist or downstream service provider for accessing both the images and for placing the application in the state used to process the images. The resulting workflow greatly facilitates access to images as well as restoration of useful states of applications used to process the images.

### BACKGROUND

The present invention relates generally to the field of medical image processing. More particularly, the invention relates to techniques for accessing, pre-processing, and finally processing medical images, such as through reads by radiologists and other medical professionals.

In a field of medical diagnostic imaging, many processes are known for generating images and for managing their distribution and use. For example, a number of imaging modalities are currently available, such as magnetic resonance imaging (MRI), computed tomography (CT), positron emission tomography (PET), ultrasound, X-ray, X-ray tomosynthesis, and so forth. In general, patients undergo such examinations to identify anatomical structures and to enable medical professionals to evaluate the anatomical features and functions for health and possible disease states, as well as response to treatment, and so forth.

In a common scenario, digital information is gathered from one of the imaging modalities mentioned above and raw image data is processed to create data that can be reconstructed into useful images. For digital systems, which now dominate the medical diagnostic medical field, the resulting image sets, typically end in the form of series of images taking during an imaging or an examination session, are stored in a large capacity memory device, such as a picture archiving and communications system (PACS). The images can be retrieved from the PACS system for pre-processing, for reading by a radiologist, and so forth. In general, some processing may be done on the image data at the imaging system itself. However, more sophisticated pre-processing is often handled by clinicians or technicians who access the data at a workstation to make the most efficient use of the time of the physician or radiologist. The images are then re-accessed by the radiologist who can more carefully examine the pre-processed images for normal and diseased tissues, progress or response to treatments, and so forth. Radiologists also typically annotate images either with text, markers on the images themselves, or a combination of inputs that memorialize the analysis made during the read.

Radiology department workflow in a typical hospital or other imaging center, however, requires that many complex analyses be performed on a multitude of different analysis workstations. The process of performing advanced analysis by a radiologist, such as to offer conclusions and treatment recommendations to referring physicians, is typically done locally at a dedicated advanced application workstation. However, as noted above, the process is usually facilitated by pre-processing of data by a technician, only after which the radiologist typically performs further analysis and storing of the results in the form of annotated screen captures, DICOM (Digital Imaging and Communications in Medicine) reports, dedicated reports, or a combination of these. The output is archived on a long term storage device, such as a PACS system, and can be made available to referring physicians.

Such workflow is, however, in need of improvement. A first issue in this typical workflow is the inconvenience cost to radiologists and technicians who essentially access and analyze the image data sequentially, at one or more advanced application workstations. There is, at present, no convenient mechanism for enabling the radiologist and technician to simply communicate when pre-processing has been completed. Even once the radiologist is informed that pre-processing is complete and that the image data is ready for analysis, the radiologist must typically log into the hospital system and manually locate an appropriate file to reload the images before analysis can be performed. This process can be time consuming and could lend itself to errors in appropriately locating the pre-processed file.

Moreover, the present workflow does not facilitate distributing reports, recommendations or other results of the analysis by radiologists to referring physicians. While the radiologists may dictate reports, save static screen captures, movie loops of key pathologies, and so forth on web servers, a referring physician, if able to access the data at all, must carefully navigate to the processed data files. In general, the referring physician cannot interact with the image data and the radiologist must directly answer any questions regarding conclusions or recommendations in person or via telephone conference.

There is, therefore, significant need for improvement in the processing and workflow of medical image data that can address such issues.

### BRIEF DESCRIPTION

The present invention provides a technique for processing medical image data designed to respond to these needs. In general, the technique may be used in a number of settings, including individual institutions, departments within institutions, and particularly between institutions, where technicians, radiologists, referring physicians and patients are not conveniently located or do not have sufficient time for direct interaction. The invention may be used with any type of medical image data acquired from any modality, and stored in a common memory location, such as a PACS system or any other suitable location.

In accordance with one exemplary embodiment medical image data is stored for retrieval, and processing. The medical image data is then accessed from a shared memory device and the image data is processed. Save-state information is generated and stored s based upon the processing. An electronic message is generated and sent an following processing the image data, the message indicating that processing of the image data has been performed, and including a link to the save-state information. The state of the processing is then restored by accessing the save-state information via the link from the message.

In accordance with another exemplary embodiment, medical image data is accessed from a shared memory device. The data is then processed, and save-state information is generated based upon the processing, the save-state information including at least information needed to restore an application used to process the image data to the state prior to saving the state. The save-state information is then stored in the shared memory device, and an electronic message is generated and sent following processing the image data, the message indicating that processing of the image data has been performed, and including either embedded save-state information or a link to the save-state information. The save-state information is then accessed via selection of the embedded information or the link from the message, and the image is further processed beginning with the state defined by the save-state information, and the image data and state may again be stored.

In yet another embodiment, medical image data is accessed from a shared memory device, and processed. Save-state information is generated based upon the processing, the save-state information including at least information needed to restore an application used to process the image data to the state prior to saving the state. The save-state information is stored in the shared memory device. A DICOM note is updated indicating the state of the save-state information, the DICOM note including a link to the save-state information. From the DICOM note, then, a user may determine that the processed image data is ready for further processing. The save-state information may be accessed via the link, and further processing the image data may be performed beginning at a processing state based upon the save-state information. Finally, the further processed image data may be stored in the shared memory device.

Software and systems for carrying out functionalities of the type summarized above are also provided.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of the inventive system for processing and storing, then exchanging medical image files to provide a much improved workflow;

FIG. 2 is a flow chart illustrating exemplary logic in pre-processing and processing image data in accordance with the system illustrated in FIG. 1;

FIG. 3 is a flow chart illustrating exemplary logic in an alternative technique for pre-processing and processing medical image date in accordance with the system of FIG. 1;

FIG. 4 is an exemplary electronic message screen used to convey a link to a save-state file or information in accordance with the invention; and

FIG. 5 is an exemplary screen illustrating a DICOM note for conveying pre-processed or processed image data files between technicians, radiologists, physicians, and other medical providers.

### DETAILED DESCRIPTION

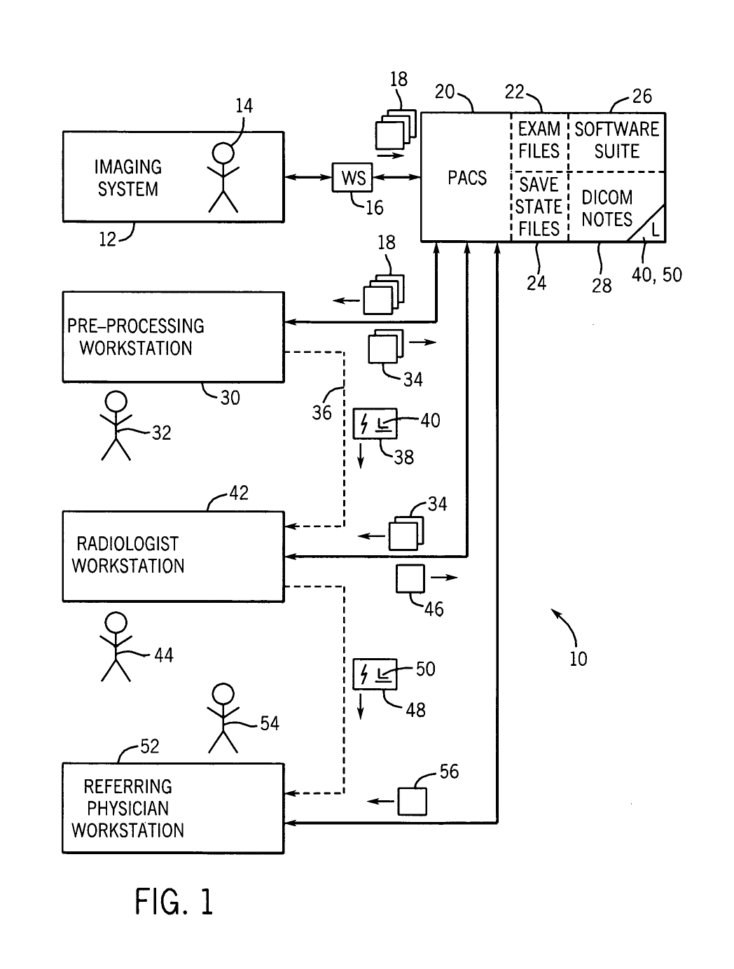

Turning now to the drawings, and referring first to FIG. 1, an image processing and analysis system, designated generally by reference numeral 10, is illustrated as including an imaging system 12 for generating diagnostic images of a patient 14. As will be appreciated by those skilled in the art, the imaging system 12 may include any current or future modality imaging system capable of making electronic images of anatomies or, more generally, features of interest in the patient. Current technologies envisaged for imaging system 12 include magnetic resonance imaging (MRI), computed tomography imaging (CT), positron emission tomography (PET), ultrasound, X-ray, X-ray tomosynthesis, and so forth, including combinations of these modalities. In general, imaging system 10 will operate under the control of one or more clinicians, technicians or radiologists, who acquire image data by interaction at a workstation 16. The workstation 16 may be wholly or partially integrated with the imaging system 12, and may partially process raw data, or even produce viewable images for the operator. The workstation 16 may also reconstruct image data based upon the physics of the particular modality of the imaging system 12. Such reconstruction may allow the operator at workstation 16 to save, pre-process, discard, or otherwise manage the images and image date acquired.

Image data files resulting from imaging sequences at imaging system 12, designated generally by reference numeral 18, will be stored by the operator interacting with workstation 16 at a shared memory device. Such memory devices may include any suitable type of memory, but most medical institutions will prefer shared memory systems for storage of large files for extended durations. In the present context, a convenience storage device is a picture archiving and communications system (PACS) 20 which can be located at a medical institution, such as in a radiology department, or at a remote location. Indeed, a number of imaging systems 12 may be interfaced with such storage devices, and many associated storage devices may be used for the invention. The PACS system 20, itself, may include a number of individual storage devices which are networked to one another for management of the image data files 18.

The system 10 also includes a number of digital tools used to store, pre-process the image data files, as well as to facilitate their management and the workflow described below. In the illustrated embodiment, the PACS system 20 will store image files 22 which may be at various stages of processing, as described below. In general, these files may be stored in accordance with convenient formats, typically conforming to standards known in the field as DICOM standards. As will be appreciated by those skilled in the art, such standards have greatly facilitated the formatting, distribution, and viewing of medical images, and provide some degree of standardization for such images, in addition to certain information relating to acquisition dates, processing dates, modality, and so forth. The image files 22 will typically be stored and associated with one another such that images saved from an examination of a patient in a particular session will be associated with one another for pre-processing, processing, and reading by radiologists. The images may also be associated in such a way to permit two-dimensional, three-dimensional, or four-dimensional (including a temporal dimension) reconstruction, processing and viewing.

The shared memory device 20 also includes save-state files or information 24. As will be appreciated by those skilled in the art, save-state technology enables certain states of an application or a system running an application to be stored for later placing the same or a different computer in the same or a similar state for further processing via the application. In general, save-state information 24 may include such information as the address and contents of registers and internal states of a central processing unit or other processor, information regarding operation of particular circuits in a computer, such as sound cards, video cards, and so forth, contents of some or all random access memory, including video, palette data and so forth, timing information, states of any peripheral devices, such as programmable read only memory, controllers, and so forth, currently selected states of memory banks for random access and read only memory, and states of any driver-specific devices. In a presently contemplated embodiment, for example, the save-state information 24 may include any information needed to restore an application, particularly the image processing application, to the state prior to performing the save-state action. Examples of such information might include the layout of the images displayed to the user, the display settings, and any segmentation or analysis done on the data.

In one particular embodiment contemplated for the invention, the same storage system 20, or another storage system may include a shared software suite 26. The software suite 26 may include application files that can be run from a shared server and that enable the pre-processing and processing described below. The use of shared server-run applications may facilitate restoring a previous state to an application in order to greatly facilitate further pre-processing or processing of image data files based upon a save-state information.

Further, the system 20 may include DICOM notes 28 for some or all of the image data files 22. As will be appreciated by those skilled in the art, such notes may be included in various types of text or reports that may be created and formatted in accordance with DICOM standards. By way of example, the notes may be a part of a structured report (SR), of which there are basic types, including basic text SR and enhanced SR files. In a particular implementation presently contemplated, the DICOM notes may include key image notes formed in accordance with DICOM standards. As will be appreciated by those skilled in the art, such key image notes are typically stored in the image archive along with the image files or image date itself, such as on PACS system 20. As described more fully below, the DICOM notes enable queries to be performed, and may summarize the state of pre-processing or processing of particular image data, or sets of files or data to facilitate workflow in accordance with the present invention. Such notes, configured in accordance with the structured reporting capabilities of DICOM, may enable messages to be conveyed between those professionals able to access the notes and image data as discussed below. Moreover, in accordance with the invention, save-state information 24 may either be embedded within or links to such save-state information may be provided within the DICOM notes for easy and ready access by subsequent service provider in the workflow chain.

In general, the images which can be reconstructed from the image data files 18 will consist of images that are sufficiently complex to require pre-processing, or sequential steps in processing. Presently contemplated image data, for example, may include multi-dimensional image data, such as three-dimensional, or image data that can be rendered in three-dimensions. Other, two-dimensional files, and four-dimensional data may, of course, be accommodated by the present techniques.

The workflow improvements offered by the invention essentially allow for technicians, clinicians, radiologists and referring physicians to interact with one another by means of the save-state information created and stored in a common or accessible memory space. The invention may make use of a database that contains user information for such service providers, such as electronic mail address, a suite of advanced processing applications that are capable of saving a state of any processing done to images being analyzed, a mechanism to remotely access the advanced applications and data, as well as an application to send electronic notifications related to the state of processing done on the image data set.

As illustrated in FIG. 1, then, a pre-processing workstation 30 is available for pre-processing the image data files 18 retrieved from the PACS system 20. An operator 32 will be familiar with the advanced application used to pre-process the images, and the processing station 30 may use an advanced application from the software suite 26 loaded from or running on a shared server. The server may be part of the PACS system 20, or separate from that system. Any suitable workstation 30 may be employed for the present purposes, such as workstations available under the commercial designation AW Advantage workstation, from General Electric Healthcare of Waukesha, Wis. Applications available for such workstations include a wide range of image pre-processing, processing, enhancement, and analysis tools for any imaging modality, and including analysis tools for specifically-directed analysis, including, by way of example only, mammography, molecular imaging, cardiology, orthopedics, oncology, and so forth. In general, such pre-processing may be performed to allow the technician 32 to select images from a series of images for consideration by a radiologist, to select regions of interest in such images, process such images and regions of interest, highlight or otherwise annotate the images, filter and alter renderings of images, perform analyses in three and four dimensions, and so forth. The analysis performed by the technician will typically be defined by the prescription or request made by the radiologist or another physician, and will be based upon the purpose for which the images were acquired. The clinician or technician 32, then, renders the time spent by the radiologist in reading and analyzing the images much more efficient and effective.

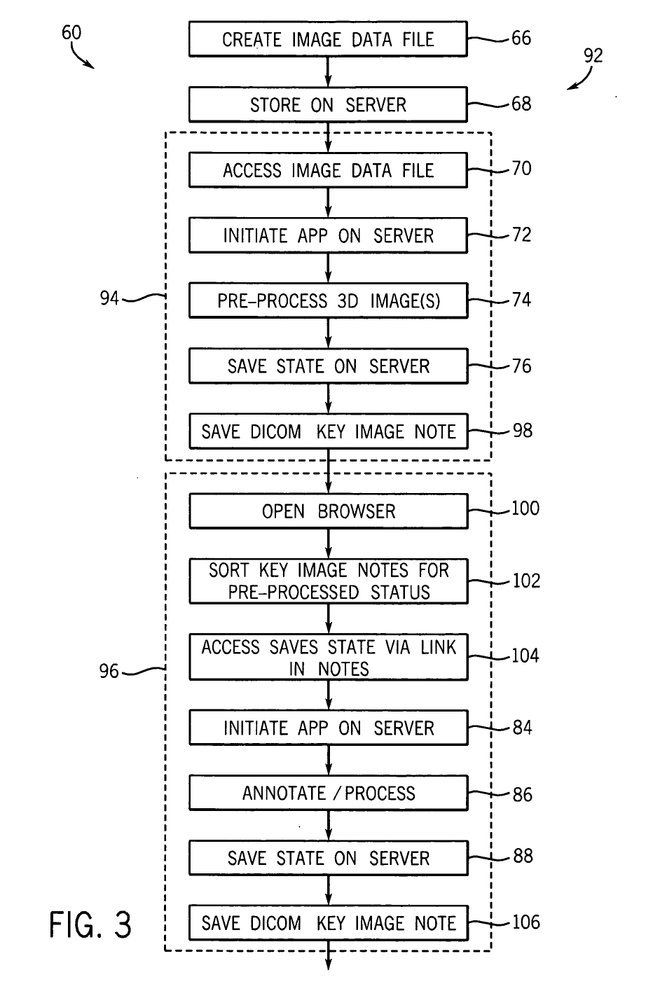

Following pre-processing at workstation 30, the pre-processed image files or data 34 are again stored on the PACS system 20, as part of the exam files 22. Moreover, in accordance with aspects of the present technique, a DICOM note 28 may be created or added, indicating that such pre-processing has been complete, and the pre-processed image data are available for review by the radiologist. Additional description of this aspect of the invention are provided below with reference to FIG. 3.

Following review by the clinician 32, an electronic message may be generated and conveyed to that radiologist as indicated generally by reference numeral 36. Such messages may be formatted and configured in accordance with standard electronic messaging protocols, such as STMP. Moreover, it should be recognized that the clinician 32 may direct such messages to the radiologist individually, or as it should be understood in the present context, to the radiologist by means of the practice, staff, institution or other extended entity associated with the radiologist. When reference is made in the present discussion or claims to messages directed to or from individuals, it should be understood that such messages can be compiled by, sent by and directed to those particular individuals or to their related staff or organizations.

In addition to storing pre-processed image data 34, the pre-processing workstation 30 generates a save-state information 24 and stores the file in a common memory device, such as PACS system 20. The ability to save the state may be provided by application itself, or by other software running on or commanded by the pre-processing workstation 30. Moreover, the save-state information 24 may be intimately associated with the pre-processed image data 34. Alternatively, the save-state information may simply save states of the advanced application used to pre-process and later to process the image data.

The electronic message 36, when conveyed from the pre-processing workstation to the radiologist as described above, may include a message file 38 which itself includes a save-state information 24 or, as in a presently contemplated embodiment, a link 40 to the save-state information. This link will typically include a URL address back to the storage device 20 and will cause an instance of the application used to process the image data to be opened and to return to the saved state in accordance with the save-state information. Moreover, as described more fully below, a similar link may be provided in a DICOM note 28, enabling the radiologist or any other medical professional enabled (e.g., permitted) to pre-process or process the image data files or to view the processed states of the files to access the files, and the saved states of the application by simply clicking on or otherwise executing the link.

A radiologist workstation 42 may be generally similar to the pre-processing workstation 30, and will enable a radiologist 42 to access the pre-processed image data and to further analyze the images, finally processing the images, such as by the addition of annotations, highlights, textual and auditory analyses, and so forth. In a presently contemplated embodiment, and summarized more fully below, two techniques are contemplated for facilitating this workflow. In a first, the radiologist 44 simply opens the save-state information 24 with any linked exam files in the form or pre-processed image data 34. This may be done via the electronic message 38 which either includes those files embedded therein or a link 40 to the files stored on the shared memory device. In a second approach, the radiologist may access DICOM key image notes 28 which, themselves, may include links to the pre-processed image data and the state of the application used to perform the analyses. Following further analysis and processing of the image data, then, the radiologist 44 may restore the processed image files or data 46 to the shared memory device 20. Moreover, a message 48 may be generated by the same technique described above, and sent to further professionals in the workflow chain, particularly to a referring physician.

In the same manner as described above, a referring physician workstation 52 may be provided, at which a referring physician 54 may access images, annotations, suggested treatments, and any other information provided by the radiologist 44. This may be performed both by accessing image data and related data directly from electronic message 48, such as via links 50 or embedded files in the message, or by access to DICOM key image notes 28 as described above. Where appropriate, limited access files 56 may be provided to the referring physician, wherein some but not all of the pre-processing or processing capabilities are enabled via the advanced application. Moreover, where the referring physician has no need to perform further analysis or manipulation of the images, access to the application and even the save-state files or information may not be required, and images may be conveyed in accordance with conventional telemedicine or teleradiology techniques.

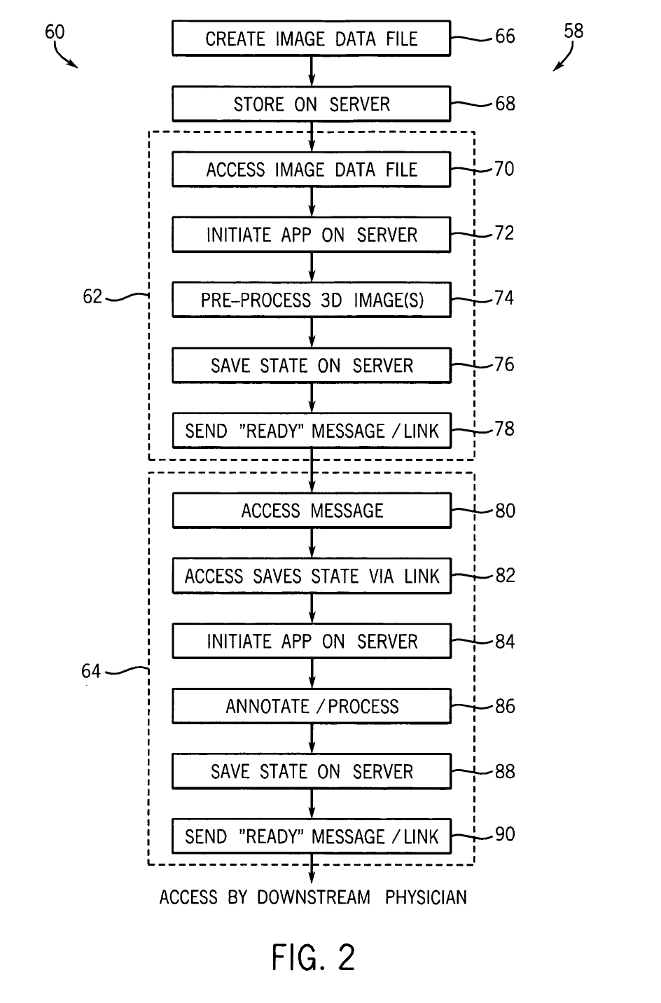

FIG. 2 is a flow chart summarizing exemplary logic in implementation of one of the workflow processes described above. The process 58 begins with image acquisition and storage steps 60, followed by pre-processing steps 62 and processing steps 64. As discussed above, the image data acquisition steps 60 will typically include creation or acquisition of image data files as indicated at step 66, followed by storing of the image data files on a shared memory device or server as indicated at step 68.

As also noted above, then, the pre-processing steps 62 include access of the image data file from the shared memory device as indicated at step 70. An application is then initiated for pre-processing the image data file. As indicated at step 72 in FIG. 2. This application may be run on the server, or, where appropriate, the application may be provided on and run directly on the pre-processing workstation. The clinician or technician, working at the pre-processing workstation then pre-processes the images as indicated at step 74 in FIG. 2. Although step 74 refers to the processing of three-dimensional images, it should be appreciated that any suitable pre-processing may be performed on any type of medical diagnostic images at this step. Once such pre-processing has been completed, the state of the application is then stored as indicated at step 76. As indicated above, the save-state file or information created at this step may include any suitable parameters or components of the state of the application running at the pre-processing station. At step 78, a “ready” message is generated and sent by the pre-processing workstation to a radiologist for reading the pre-processed images. This message may include the save-state file or information embedded therein, or, as in a presently contemplated embodiment, a link to the file.

The processing steps 64 may then be initiated at the convenience of the radiologist, without requiring the radiologist to search for and manually access either the pre-processed files themselves or to set the application back into a state or condition in which it was last found when the pre-processing was completed by the clinician. In particular, the state may be restored by the radiologist accessing the electronic messages indicated at step 80, followed by accessing the saved state of the application via the embedded file or link, as summarized at step 82. Once the file or link has been selected (e.g., clicked on) by the radiologist, then, the application for processing the pre-processed image data is initiated as indicated at step 84. As noted above, the application is restored to the state in which it was found following pre-processing, as summarized by the save-state information. As also noted above, the application which is restored to such state may operate (i.e., run) either on the local workstation or on the server. The radiologist then completes the annotation and processing of the image data file in a manner similar to that used in the prior art as indicated at step 86. However, following such processing, the radiologist may once again save the state of the application, as indicated at step 88. This saving of the state may be similar or identical to that performed at step 76, and will capture not only the image data then being processed, but certain aspects of the state of the application upon completion of the processing. Finally, as indicated at step 90 in FIG. 2, the radiologist may send a “ready” message with an embedded file or link to any downstream service providers, such as the referring physician. Access and processing or viewing by the referring physician will generally reproduce those steps summarized in the processing phase 64 described above, although the referring physician may not have a need to process or otherwise analyze the files via the applications, or save the state of any further processing.

FIG. 3 is a flow chart illustrating exemplary steps in logic for carrying out the technique described above which is based on DICOM key image note generation. The process 92 summarized in FIG. 3 again begins with acquisition and storage of image data files as indicated by reference numeral 60 followed by pre-processing steps 94 and processing step 96.

The pre-processing steps summarized in FIG. 3 begin with access by the clinician or the technician at a pre-processing workstation of the image data files, as indicated by reference numeral 70. Steps 70, 72, 74 and 76 may be essentially identical to those described above with reference to FIG. 2. However, following saving the state of the pre-processed image data files and the processing application at step 76, the pre-processing steps 94 may terminate with saving a DICOM key image note as described above and as indicated by step 98 in FIG. 3. The key image note will typically include such information as the date and time, the identification of the clinician or technician performing the pre-processing, links to the image data files and/or the save-state information. As will be appreciated by those skilled in the art, then, such DICOM key image notes may be sorted by certain parameters stored in the notes. In a presently contemplated embodiment, such parameters might include the state of processing, such as designating whether the images have been pre-processed or simply whether the images or files are ready for reading by a radiologist.

The processing steps 96, then, may begin with the radiologist or a radiologist assistant simply opening a browser on the processing workstation to be used by the radiologist, as indicated at step 100. At step 102, then, the key image notes may be sorted so as to group pre-processed image files or data (typically grouped by exam sequences for particular exam sessions and patients). This sorting will effectively produce a work list for the radiologist who may then access both the pre-processed images and the saved state of the application by simply selecting a link provided in the DICOM note as indicated at step 104. Once the radiologist has accessed the pre-processed images and the saved state of the application, then, the application may be run either on the processing workstation or from the server, followed by the processing as indicated at steps 84, 86 and 88, which may be essentially identical to those described above with reference to FIG. 2. However, at step 106, the radiologist may save a DICOM key image note summarizing the state of the processing as “read” or “processed” or by any other suitable state designation. The note may also include a link to the image data files and/or to the state of the application upon completion of a particular image data file series read. This image note may then allow a subsequent service provider, such as a referring physician, to access the processed or read images.

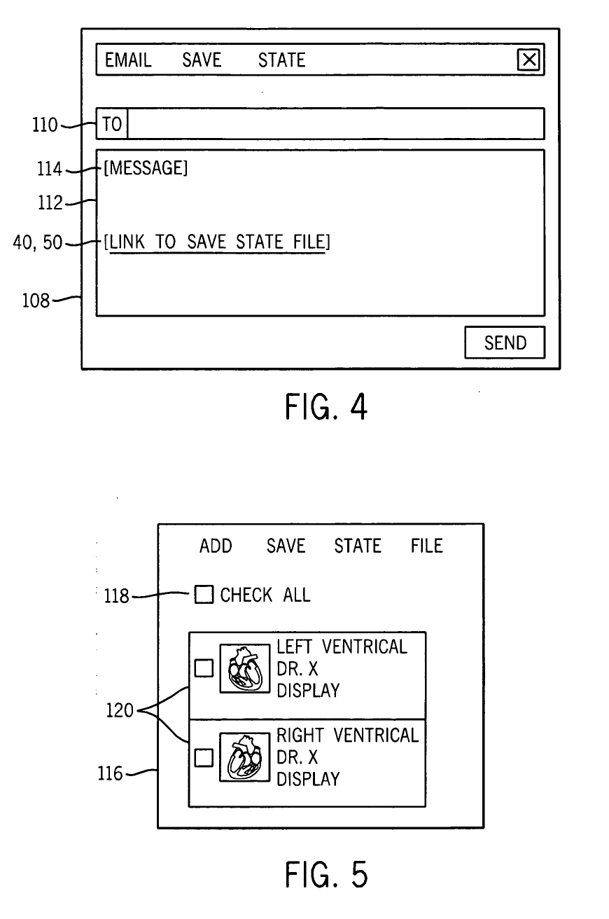

FIG. 4 is an exemplary presentation of an electronic message which may be used in accordance with the messaging scenario outlined above. As will be apparent to those skilled in the art, the message is formulated in a message window 108 and will include an addressee line 110 which may be filled in automatically or manually by either the clinician or technician who pre-processes the image data files, or by a radiologist or other medical professional following processing. The message includes a text space 112 where any suitable message maybe automatically or manually input, such as to indicate status, discuss recommendations, and so forth. The message itself 114 is input into this space. Finally, an embedded file or a link to the save-state information is provided in the message, as indicated generally at reference numerals 40, 50. This link or file may be selected by a user, causing the application used to pre-process or process the image data file to be run and restored to a state present upon completion the pre-processing or processing, as indicated by the information in the save-state information.

FIG. 5 is a simplified view of an exemplary DICOM note which may be used in conjunction with the second scenario outlined above. In the view shown in FIG. 5, then, a DICOM note window 16 may be accessed, and in practice a series of such notes may be accessed and sorted for selection of examination sequences that are available for reading or further processing. Various graphical tools may be provided in the window, such as indicated at reference numeral 118, for selection of one or more images to be displayed for further processing. Individual images may be called out as indicated at reference numeral 120, permitting these images particularly to be accessed for further processing. Although not illustrated in FIG. 5, a particular state of the processing may also be indicated by a parameter box in the DICOM note window 116, as well as text input for consideration by others in the medical service workflow.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for processing a medical image comprising:
accessing medical image data;
processing the image data;
generating and storing save-state information based upon the processing;
generating and sending an electronic message following processing the image data, the message indicating that processing of the image data has been performed, and including a link to the save-state information;
restoring the state of the processing by accessing the save-state information via the link from the message.

2. The method of claim 1, wherein further processing of the image data is performed from the restored state.

3. The method of claim 2, wherein the restored state of the processing is used by a radiologist to make a diagnosis of a patient medical condition.

4. The method of claim 1, wherein the restored state of the processing contains a diagnosis of a patient condition.

5. The method of claim 1, comprising storing the save-state information on shared memory device with the image data.

6. The method of claim 5, wherein the shared memory device is a picture archiving and communications system.

7. The method of claim 1, wherein processing the image data is performed by via an application running on a shared server.

8. The method of claim 1, wherein the electronic message is sent to a radiologist designated to read an image based upon the processed image data.

9. The method of claim 8, comprising generating and sending a referring physician message from the radiologist to a referring physician following further processing of the image data.

10. The method of claim 8, wherein the referring physician message includes a link to the save-state information.

11. The method of claim 1, comprising generating a DICOM note following processing of the image file, the DICOM note indicating that further processing of the image data has been performed.

12. The method of claim 11, wherein the DICOM note is stored in a shared memory device with the image data.

13. The method of claim 11, wherein the DICOM note includes a link to the save-state information.

14. The method of claim 1, wherein the save-state information includes at least information needed to restore an application used to process the image data to the state prior to saving the state.

15. The method of claim 14, wherein the save-state information includes at least one of layout of the images displayed to a user, display settings, and segmentation or analysis done on the image data.

16. A method for processing a medical image comprising:
accessing medical image data;
processing the image data;
generating save-state information based upon the processing, the save-state information including at least information needed to restore an application used to process the image data to the state prior to saving the state;
storing the save-state information;
generating and sending an electronic message following processing the image data, the message indicating that processing of the image data has been performed, and including either embedded save-state information or a link to the save-state information;
accessing the save-state information via selection of the embedded information or the link from the message;
further processing the image data beginning with the a state defined by the save-state information; and
storing the further processed image data.

17. The method of claim 16, wherein processing the image data is performed by via an application running on a shared server.

18. The method of claim 16, wherein the electronic message is sent to a radiologist designated to read an image based upon the processed image data.

19. The method of claim 18, comprising generating a sending a referring physician message from the radiologist to a referring physician following further processing of the image data.

20. The method of claim 16, comprising generating a DICOM note following processing of the image data, the DICOM note indicating that processing of the image data has been performed.

21. The method of claim 20, wherein the DICOM note is stored in a shared memory device with the image data.

22. A method for processing a medical image comprising:
accessing medical image data;
processing the image data;
generating save-state information based upon the processing, the save-state information including at least information needed to restore an application used to process the image data to the state prior to saving the state;
storing the save-state information;
updating a DICOM note indicating the state of the save-state information, the DICOM note including a link to the save-state information;
identifying from the DICOM note that the processed image data is ready for further processing;
accessing the save-state information via the link;
further processing the image data beginning at a processing state based upon the save-state information; and
storing the further processed image data.

23. A system for processing a medical image comprising:
a shared memory device for storing a medical image data;
a processing work station for accessing the image data from the shared memory device and processing the image data, the pre-processing station being configured to enable generation and storing of a save-state information based upon the processing, the processing work station also being configured to generate and send an electronic message following processing the image data, the message indicating that processing of the image data has been performed, and including either the save-state information or a link to the save-state information; and
a further processing work station configured to access the save-state information and to process the image data beginning with a processing state as defined by the save-state information.

24. The system of claim 23, wherein the processing work station and the further processing work station are different work stations.

25. The system of claim 23, wherein the processing work station and the further work station perform processing via software running on a shared server.

26. The system of claim 23, wherein the save-state information is stored on the shared memory device, and wherein the further processing work station is configured to retrieve the save-state information from the shared memory device.

27. The system of claim 26, wherein the further processing work station is configured to store the image data on the shared memory device following processing.

28. The system of claim 23, comprising DICOM notes stored on the shared memory device, the DICOM notes including an indication that processing has been performed following processing of the image data on the processing work station.

29. A system for processing a medical image comprising:
save-state information generated and stored following processing of a medical image data, the save-state information including at least information needed to restore an application used to process the image data to the state prior to saving the state

30. The system of claim 29, wherein the save-state information is stored on a picture archiving and communications system.

31. The system of claim 29, further comprising a DICOM note including an indication of the state of the save-state information.

32. The system of claim 31, wherein the DICOM note includes a link to the save-state information.

33. An electronic message including an indication that processing of medical diagnostic image data has been performed, and including either save-state information or a link to save-state information that captures a state of an application used to process the medical diagnostic image data.

34. A DICOM note indicating a processing state of medical diagnostic and including a link to save-state information that captures a state of an used to process the medical diagnostic image data.
